(19) United States
(12) Patent Application Publication
(10) Pub. No.: US 2014/0250900 A1
(43) Pub. Date: Sep. 11, 2014

(54) GAS TURBINE POWER PLANT WITH CARBON DIOXIDE SEPARATION

(71) Applicant: ALSOM Technology Ltd., Baden (CH)

(72) Inventors: Richard CARRONI, Niederrohrdorf (CH); Alexander ZAGORSKIY, Wettingen (CH); Klara BERG, Brugg (CH); Sergey KHAYDAROV, Wettingen (CH); Marcel RIEKER, Niedergosgen (CH)

(21) Appl. No.: 14/282,174

(22) Filed: May 20, 2014

Related U.S. Application Data
(63) Continuation of application No. PCT/EP2012/074482, filed on Dec. 5, 2012.

(30) Foreign Application Priority Data
Dec. 7, 2011 (EP) 11192431.2

(51) Int. Cl. F01K 23/10; F02C 7/00

(52) U.S. Cl. CPC F01K 23/101; F02C 7/00
USPC 60/772; 60/39.182; 60/39.5

(57) ABSTRACT

The invention relates to a gas turbine power plant, having a gas turbine, a waste heat steam generator following the gas turbine, an exhaust gas recooler, an exhaust gas blower, a carbon dioxide separation plant which separates the carbon dioxide contained in the exhaust gases from these and discharges it to a carbon dioxide outlet. A bypass chimney is arranged in the gas turbine power plant between the outlet of the waste heat steam generator and the exhaust gas blower and is connected to a fail-safe open connection both in the throughflow direction from the exhaust gas line to the bypass chimney and in the throughflow direction from the bypass chimney to the exhaust gas line. The invention relates, further, to a method for operating a gas turbine power plant of this type, in which the exhaust gas blower is regulated.

### CROSS-REFERENCE TO RELATED APPLICATIONS

This application claims priority to PCT/EP2012/074482 filed Dec. 5, 2012, which claims priority to European application 11192431.2 filed Dec. 7, 2011, both of which are hereby incorporated in their entireties.

### TECHNICAL FIELD

The present invention relates to an exhaust gas system for a gas turbine combined-cycle power plant with carbon dioxide separation from the exhaust gases.

### BACKGROUND

Carbon dioxide emissions as greenhouse gases contributing appreciably to global warming are known. In order to reduce the carbon dioxide emissions of gas turbine power plants in order thereby to prevent global warming, various arrangements and methods have been proposed. The most technically advanced methods seem to be those in which carbon dioxide is separated from the exhaust gas stream of the power plant by absorption or adsorption. Typically, the useful waste heat from a gas turbine is used further in a profitable way for energy recovery in a following waste heat recovery boiler. The exhaust gases are thereby cooled, but usually do not yet reach the temperature level necessary for absorption or adsorption, and therefore they are typically cooled further in a recooler before they are introduced into a carbon dioxide separation plant. In this, carbon dioxide is separated from the exhaust gases and discharged for further use. The exhaust gases low in carbon dioxide are discharged into the environment via a chimney. A plant of this type is known, for example, from WO2011/039072.

Further, the use of a blower for overcoming the pressure loss of the carbon dioxide separation plant is known from EP2067941.

However, the use of a blower for overcoming the pressure loss of the carbon dioxide separation plant is not without its problems. A blower of this type has to convey large volume flows and has correspondingly large dimensioning and high inertia.

### SUMMARY

In the event of rapid changes in the operating conditions of the gas turbine which lead to major changes in the exhaust gas volume flow within a short time, the blower cannot follow the rapid transients without additional measures. Particularly in the event of load shedding or an emergency shutdown (trip) of the gas turbine, the exhaust gas volume flow falls significantly within a few seconds as a result of the rapid closing of the compressor guide vanes and a reduction in the exhaust gas temperature. During an emergency shutdown, the exhaust gas volume flow may fall to 50% or less of the full-load exhaust gas flow within 5 to 10 seconds. A typical exhaust gas blower has no adjustable guide vanes, and because of its high inertia it runs down slowly, even when its drive is switched off immediately, and still conveys a volume flow which is markedly above the reduced exhaust gas flow of the gas turbine. As a result of this difference is the volume flows, a dangerous vacuum may be generated in the waste heat recovery boiler and the exhaust gas lines and in the worst case may lead to an implosion of the waste heat recovery boiler.

One aim of the present disclosure is to specify a gas turbine power plant with carbon dioxide separation from the exhaust gases, in which, even in the event of rapid changes in the operating conditions, no hazardous pressure differences inherently arise between the exhaust gas side in the waste heat recovery boiler or the exhaust gas ducts and the surroundings. In addition to the gas turbine power plant, a method for operating a gas turbine power plant of this type is also the subject of the invention.

A gas turbine power plant with carbon dioxide separation comprises a gas turbine, a waste heat steam generator following the gas turbine, an exhaust gas blower, a carbon dioxide separation plant which separates the carbon dioxide contained in the exhaust gases from these and discharges it to a carbon dioxide outlet, and a chimney.

Moreover, an exhaust gas recooler is typically arranged between the waste heat recovery boiler and exhaust gas blower. The gas turbine, waste heat recovery boiler, exhaust gas recooler, exhaust gas blower, carbon dioxide separation plant and chimney are connected by means of exhaust gas lines or exhaust gas ducts. The exhaust gas blower is typically arranged downstream of the exhaust gas recooler, since the blower then has to convey a lower volume flow and is also exposed to lower temperatures.

According to one version of the gas turbine power plant with carbon dioxide separation, a bypass chimney is arranged between the outlet of the waste heat steam generator and the exhaust gas blower and is connected to a fail-safe open connection both in the throughflow direction from the exhaust gas line to the bypass chimney and in the throughflow direction from the bypass chimney to the exhaust gas line. The opening, fail-safe in both throughflow directions, advantageously issues into the bypass chimney, since the hazardous region of the opening (outflow of hot gases or suction into the hot exhaust gas lines) is reliably protected.

According to a further version of the gas turbine power plant with carbon dioxide separation, the connection of the bypass chimney to the exhaust gas line has a defined pressure threshold beyond which the gas throughflow from the exhaust gas line into the bypass chimney is unobstructed. Unobstructed means, for example, that, in addition to the inlet loss into the chimney, no additional pressure losses in the inlet occur which are higher than the inlet losses themselves (that is to say, the inlet pressure losses from the exhaust gas line in the chimney without additional fittings), or the additional pressure losses are at most one order of magnitude higher than the inlet pressure losses.

Further, the pressure threshold for overpressure and underpressure can be selected as a function of the pressure losses in the exhaust gas system. For example, it should lie in the order of magnitude of up to one third of the pressure losses of the waste heat recovery boiler. Typically, a pressure threshold of 3 to 10 mbar, preferably about 5 mbar, is suitable for ensuring reliable operation.

For a differential pressure between the inside of the exhaust gas line and the surroundings which is lower than this pressure threshold, the throughflow through the bypass chimney can be ignored, that is to say is lower than 10% of the overall throughflow through the exhaust gas line. Depending on the particular version and the operating state, during stationary operation a throughflow through the bypass chimney of up to 20% of the overall throughflow through the exhaust gas line can be accepted.

According to one version of the gas turbine power plant with carbon dioxide separation, the connection of the bypass chimney to the exhaust gas line has a flap and a stop, the stop being arranged in such a way that the flap does not close completely so that it has a minimum opening even in a closed position. This minimum opening allows a throughflow in the throughflow direction from the bypass chimney to the exhaust gas line. The throughflow capacity through the minimum opening from the bypass chimney to the exhaust gas line is typically at most 10% of the throughflow capacity in the throughflow direction from the exhaust gas line to the bypass chimney, with the flap open. The flap in this case opens in the throughflow direction from the exhaust gas line to the bypass chimney as soon as a defined pressure threshold is overshot.

According to a further version of the gas turbine power plant with carbon dioxide separation, the connection of the bypass chimney to the exhaust gas line comprises a main flap and a secondary flap. In this case, the main flap is open, fail-safe, in the throughflow direction from the exhaust gas line to the bypass chimney, and the secondary flap is open, fail-safe, in the throughflow direction from the bypass chimney to the exhaust gas line. The main flap and secondary flap open in the respective throughflow direction as soon as a pressure threshold is overshot. This pressure threshold may be identical for both flaps or else be defined separately.

According to a further version of the gas turbine power plant with carbon dioxide separation, the connection of the bypass chimney to the exhaust gas line comprises a multiplicity of alternately arranged outward-opening sub flaps and inward-opening sub flaps. The outward-opening sub flaps are in each case open, fail-safe, in the throughflow direction from the exhaust gas line to the bypass chimney. The inward-opening sub flaps are in each case open, fail-safe, in the throughflow direction from the bypass chimney to the exhaust gas line.

These flaps, too, open in the respective throughflow direction as soon as a pressure threshold is overshot, and in this case the pressure thresholds may be defined separately for both throughflow directions.

According to one version of the gas turbine power plant with carbon dioxide separation, the bypass chimney is divided into two ducts at the connection to the exhaust gas line by means of a partition, there being arranged in one duct an outlet flap which is open, fail-safe, in the throughflow direction from the exhaust gas line to the bypass chimney, and there being arranged in the second duct an inlet flap which is open, fail-safe, in the throughflow direction from the bypass chimney to the exhaust gas line.

By means of the partition, the bypass chimney is divided into two ducts, for example, for up to 20% of its height, before this partition ends and the chimney is led further on as a single duct to a tip. As a result of separation into two ducts, the narrowing in cross section of the respective flaps is reduced or even avoided entirely, and the pressure loss across the open flap can thus be reduced.

These flaps, too, open in the respective throughflow direction as soon as a pressure threshold is overshot, and in this case the pressure threshold may be defined separately for both throughflow directions.

According to a further version of the gas turbine power plant with carbon dioxide separation, the bypass chimney is connected to the exhaust gas line via a chimney elbow. The chimney elbow is connected to the exhaust gas line from below and has a U-shaped deflection, the U-shaped deflection issuing into the bypass chimney.

In normal operation with carbon dioxide separation, the exhaust gas is hotter than the gases in the chimney elbow. The gases in the chimney elbow are therefore heavier and counteract an inflow of exhaust gas into the elbow. Even when exhaust gas flows into the connection region of the chimney elbow as a result of turbulence, this exhaust gas is flushed back due to the thermal pressure difference occurring in this case. Moreover, the U-shaped deflection leads to an additional pressure loss, so that, with pressure conditions equalized, virtually no gas flows through the bypass chimney during normal stationary operation of the plant. However, as soon as the chimney elbow is filled with hot exhaust gases and the pressure loss is overcome as a result of the deflection, the exhaust gas can flow out, without further detriment, through the bypass chimney for the purpose of bypass operation. To this effect, for example, the exhaust gas line is closed downstream of the bypass chimney by means of a flap.

Further, in the event of underpressure in the exhaust gas lines, circulating air can easily flow into the exhaust gas line through the bypass chimney and the chimney elbow. For this, the underpressure must simply be sufficiently great to overcome the pressure losses of the deflection and inlet pressure losses.

In a further version of the gas turbine power plant with carbon dioxide separation, a water barrier is arranged at the connection of the bypass chimney to the exhaust gas line or in the bypass chimney and comprises a basin which is filled at least partially with water and into which a blow-out duct extends from the exhaust gas line from above and a blow-in duct extends from the bypass chimney from above. In the closed state of the water barrier, the walls of the blow-out duct and of the blow-in duct reach under the water surface, so that no gas can flow through the water barrier. As a result of overpressure in the respective duct, the water is at least partially displaceable out of the basin so that the water lock can be transferred into an open state. As soon as so much water is displaced that gas flows through under the respective duct end, the water barrier is released and gas can flow through it. In the case of a sufficiently high overpressure in the exhaust gas line, the water is displaced in the direction of the bypass chimney and bypass operation is possible as soon as exhaust gas has reached the lower edge of the blow-out duct. With a sufficiently high underpressure in the exhaust gas line, the water is displaced in the direction of the exhaust gas line and it is possible for air to be sucked in from the bypass chimney as soon as the gases from the bypass chimney have reached the lower edge of the blow-in duct. The height of the water column at which gas throughflow becomes possible determines the pressure threshold for both throughflow directions.

In addition to the gas turbine power plant, a method for operating a gas turbine power plant with carbon dioxide separation, which comprises a gas turbine, a waste heat steam generator following the gas turbine, an exhaust gas blower, a carbon dioxide separation plant which separates carbon dioxide contained in the exhaust gases from these and discharges it to a carbon dioxide outlet, and a chimney, is also the subject of the disclosure. Typically, a power plant of this type comprises further, between the waste heat steam generator and exhaust gas blower, an exhaust gas recooler. In a gas turbine power plant of this type, the gas turbine, waste heat recovery boiler, exhaust gas recooler, exhaust gas blower, carbon dioxide separation plant and chimney are connected by means of exhaust gas lines. A bypass chimney is arranged between the outlet of the waste heat steam generator and the exhaust gas blower and is connected to a fail-safe open connection both in the throughflow direction from the exhaust gas line to the bypass chimney and in the throughflow direction from the bypass chimney to the exhaust gas line. By means of a regulatable exhaust gas blower, the differential pressure between the inside of the exhaust gas line and the surroundings at the connection of the bypass chimney to the exhaust gas line can be regulated such that it remains lower than a defined pressure threshold. The pressure threshold is to be selected such that safe operation is ensured at all times. In particular, it must be selected such that safe operation of the waste heat steam generator is ensured. For this purpose, the pressure threshold selected must be lower than a design pressure difference of the waste heat steam generator. This is the difference between the exhaust gas pressure in the waste heat recovery boiler and the ambient pressure for which the waste heat recovery boiler is designed. The pressure threshold is therefore lower than the maximum permissible difference between the exhaust gas pressure in the waste heat steam generator and the ambient pressure. Preferably, two pressure thresholds, that is to say a pressure threshold for overpressure and a pressure threshold for underpressure, are used in the exhaust gas line or the waste heat recovery boiler. The pressure losses between the waste heat steam generator and bypass chimney may advantageously be taken into account in defining the pressure threshold.

During normal operation with carbon dioxide separation, no gases should escape through the bypass chimney and also no fresh ambient air should be sucked in through the bypass chimney.

A bypass chimney which is connected to a fail-safe open connection in the throughflow direction from the exhaust gas line to the bypass chimney allows the bypass operation of the gas turbine with the waste heat recovery boiler when carbon dioxide separation is not operative. Moreover, typically, for this operating mode a flap is arranged downstream of the bypass chimney in the exhaust gas line. Further, the fail-safe open connection prevents the situation where, in the event of failure of the exhaust gas blower, the pressure in the waste heat recovery boiler and the back pressure for the gas turbine rise above the design pressures.

A bypass chimney which is connected to a fail-safe open connection in the throughflow direction from the bypass chimney to the exhaust gas line prevents the situation where, in the event of too high a volume flow of the exhaust gas blower, the pressure in the exhaust gas lines, the boiler and the exhaust gas recooler between the gas turbine and exhaust gas blower is lowered too much, which would lead to the risk of implosion of the exhaust gas tract. Such an operating state may occur, for example, during an emergency shutdown of the gas turbine when the exhaust gas volume flow of the gas turbine is lowered within a short time, that is to say within seconds, and the exhaust gas blower runs down slowly and still conveys a high volume flow, for example, for 10 to 20 seconds. Even when, in the event of load shedding, the compressor guide vanes are closed very quickly and the exhaust gas mass flow is thereby appreciably reduced within a short time, that is to say within an order of seconds, underpressure may occur in the exhaust gas lines and the waste heat recovery boiler. Depending on the design and type of operation, the exhaust gas mass flow may be reduced, for example, by up to 50% during load shedding. Since the exhaust gas temperature falls at the same time, the volume flow may fall to an even greater extent, so that an exhaust gas blower with a slow regulating characteristic conveys too much exhaust gas out of the exhaust gas tract and hazardous operating states may likewise arise.

All the advantages explained can be used not only in the combinations specified in each case, but also in other combinations or alone, without departing from the scope of the invention. For example, the water barrier may be combined with a U-shaped chimney connection or with all other fail-safe open connections described. The chimney elbow, too, may be combined with all other fail-safe open connections described.

### BRIEF DESCRIPTION OF THE DRAWINGS

Preferred embodiments of the invention are described below by means of the drawings which serve merely for explanatory purposes and are not to be interpreted restrictively. In the drawings, for example,

FIG. 1 shows a diagrammatic illustration of a gas turbine power plant with an exhaust gas blower and bypass chimney;

FIG. 2 shows a diagrammatic illustration of a gas turbine power plant with an exhaust gas blower and bypass chimney and also the pressure profile in the exhaust gas lines;

FIG. 3 shows a diagrammatic illustration of a bypass chimney with a flap which has minimum opening even in a closed position;

FIG. 4 shows a diagrammatic illustration of a bypass chimney with a main flap and a secondary flap;

FIG. 5 shows a diagrammatic illustration of a bypass chimney with a multiplicity of alternately arranged outward-opening and inward-opening sub flaps;

FIG. 6 shows a diagrammatic illustration of a bypass chimney which is divided into two ducts by a partition, in each case an outlet or inlet flap being arranged in a duct;

FIG. 7 shows a diagrammatic illustration of a bypass chimney with a chimney elbow which is connected at the exhaust gas line from below and which issues after a U-shaped deflection into the bypass chimney;

FIG. 8 shows a diagrammatic illustration of a bypass chimney with a water barrier.

### DETAILED DESCRIPTION

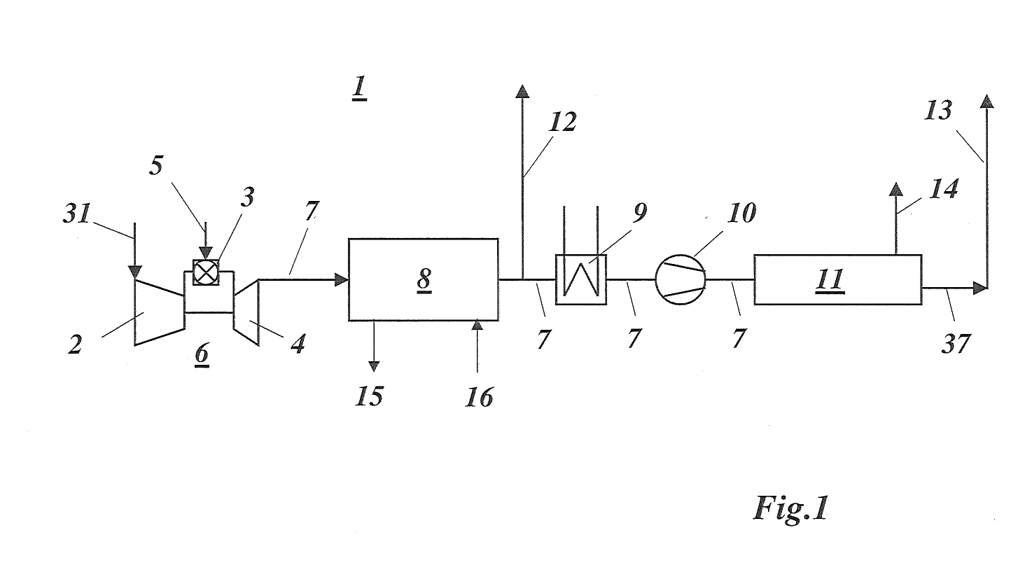

FIG. 1 shows a diagrammatic illustration of the essential elements of a gas turbine power plant according to the invention. The gas turbine 6 comprises a compressor 2, the combustion air compressed therein being delivered to a combustion chamber 3 and being burnt there with fuel 5. The hot combustion gases are subsequently expanded in a turbine 4. The useful energy generated in the gas turbine 6 is then converted into electrical energy, for example, by means of a generator (not illustrated) arranged in the same shaft.

The hot exhaust gases emerging from the turbine 4 are conducted through an exhaust gas line 7 for the optimal utilization of the energy still contained in them in a waste heat steam generator 8 (Heat Recovery Steam Generator, HRSG) and are used for evaporating feed water 16 and for generating fresh steam 15 for a steam turbine (not illustrated) or for other plants. The steam circuit is indicated merely diagrammatically by the waste heat recovery boiler 8. The steam turbine, condenser, various pressure stages, feed water pumps, etc. are not shown since these are not the subject of the invention.

The exhaust gases from the waste heat steam generator 8 are conducted further on, downstream of the waste heat steam generator 8, through the exhaust gas line 7 in an exhaust gas recooler 9. In this exhaust gas recooler 9, which may be equipped with a condenser, the exhaust gases are cooled to somewhat (typically 5° C. to 20° C.) above ambient temperature. Downstream of this exhaust gas recooler 9, in the exhaust gas line 7, an exhaust gas blower 10 is arranged which is followed by a carbon dioxide separation plant 11. In this carbon dioxide separation plant 11, carbon dioxide is separated out of the exhaust gases and discharged via a carbon dioxide outlet (14). The separated carbon dioxide can then, for example, be compressed for further transport.

The exhaust gas 37, low in carbon dioxide, from the carbon dioxide separation plant 11 is discharged into the surroundings via a chimney. The pressure loss of the carbon dioxide separation plant 11 can be overcome by means of the exhaust gas blower 10. Depending on the design and back pressure of the gas turbine 6 or waste heat steam generator 8, moreover, the pressure loss of the recooler 9, of the exhaust gas lines 7, of the chimney 13 and/or of the waste heat steam generator can also be overcome by means of the exhaust gas blower 10.

Upstream of the exhaust gas recooler 9 is arranged a bypass chimney 12 which makes it possible to operate the gas turbine and waste heat recovery boiler when the carbon dioxide separation plant 11 is not operative, for example for maintenance work. In normal operation, the inlet to the bypass chimney 12 is closed, so that all the exhaust gases are discharged into the surroundings through the recooler 9, the exhaust gas blower 10, the carbon dioxide separation plant 11 and the chimney 13. In bypass operation, the inlet into the bypass chimney 12 is opened, so that the exhaust gases can be discharged into the surroundings directly via the bypass chimney 12. To regulate the exhaust gas streams, flaps or valves may be arranged in the exhaust gas lines 7 and the bypass chimney 12. For example, a flap (not shown) may be arranged in the exhaust gas line 7 between the bypass chimney and exhaust gas recooler 9, in order to suppress flow into the recooler in the event of a shutdown of the carbon dioxide separation plant 11.

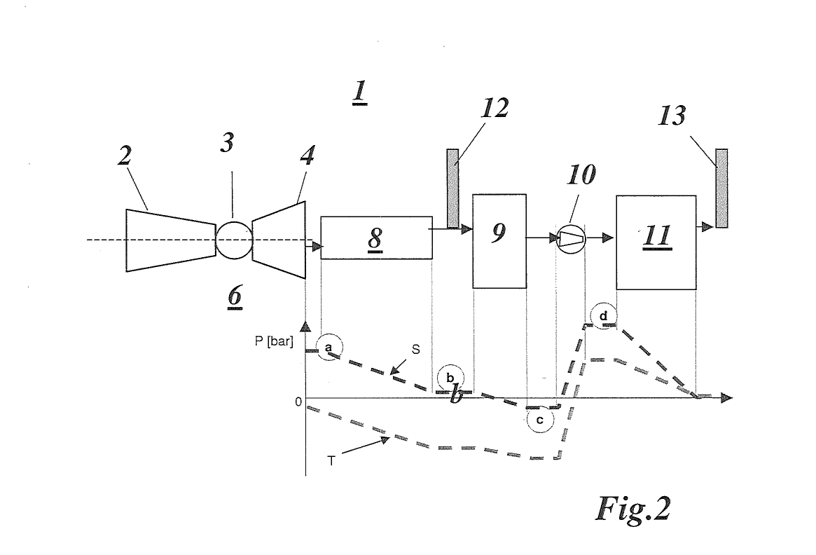

FIG. 2 shows the plant from FIG. 1 in even more simplified form. In addition, the pressure profile in the exhaust gas line 7, the waste heat steam generator 8, the exhaust gas recooler 9, the exhaust gas blower 10 and the carbon dioxide separation plant 11 is indicated for standard operation S and for the critical operating state during a trip T (emergency shutdown).

The pressure profile for standard operation S is selected in the example shown such that, as far as the bypass chimney 12, it corresponds to the pressure profile in a conventional gas turbine combined-cycle power plant, that is to say the pressure a at the outlet of the turbine is so high that the pressure loss of the waste heat recovery boiler 8 is thus overcome. Downstream of the waste heat recovery boiler 8, the pressure b is virtually identical to the ambient pressure. Downstream of the exhaust gas recooler 9, the pressure c falls below the ambient pressure before it is raised by the exhaust gas blower 10 to a pressure d which is sufficiently high to overcome the pressure loss of the carbon dioxide separation plant 11 and discharge the exhaust gases into the surroundings via the chimney 13. The exhaust gas blower 10 is regulated such that the pressure at the inlet of the bypass chimney 12 is virtually identical to the ambient pressure.

Starting from the pressure profile for standard operation S, the pressure in the exhaust gas tract, in the event of a trip T, falls within a few seconds, since the exhaust gas blower conveys a higher exhaust gas stream than emerges from the turbine. The pressure is below ambient pressure as early as at the outlet of the turbine. The pressure falls further due to the pressure loss of the exhaust gas lines 7, waste heat recovery boiler 8 and exhaust gas recooler 9. The underpressure in the waste recovery boiler 8 and recooler 9 and also in the exhaust gas lines 7 may in this case become dangerously high. The pressure is raised again only by the exhaust gas blower 10 to an extent such that the pressure loss, reduced in proportion to the volume flow, of the carbon dioxide separation plant 11 can be overcome.

In order both to allow bypass operation and to safely avoid a high underpressure, a fail-safe open connection, which opens, fail-safe, both in the throughflow direction from the exhaust gas line 7 to the bypass chimney 12 and in the throughflow direction from the bypass chimney 12 to the exhaust gas line 7, is proposed.

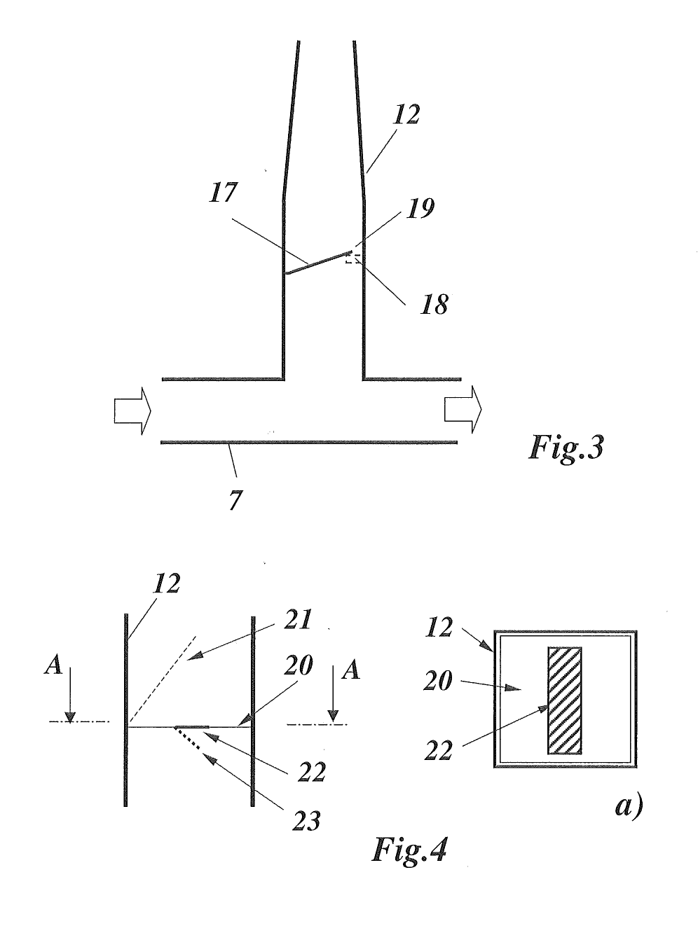

An exemplary embodiment of a fail-safe open connection is shown in FIG. 3. This shows a diagrammatic illustration of an exhaust gas line 7 which a bypass chimney 12 adjoins. In the connection region of the bypass chimney 12, a flap 17 is provided which opens in the flow direction to the bypass chimney beyond a defined pressure threshold, that is to say an opening pressure difference. Below the opening pressure difference, the flap 17 is closed. However, gas-tight closing of the flap 17 is prevented by a stop 18. With the stop 18 being in a suitable position, a minimum throughflow which can flow through the flap 17 out of the bypass chimney into the exhaust gas line can be set.

The minimum throughflow through the bypass chimney 12 and the flap 17 is to be selected as a function of the volume of the exhaust gas lines 7 between the gas turbine 6 and exhaust gas blower 10 and of the waste heat recovery boiler 8 and recooler 9 and also the difference between the run-out characteristic of the volume flow of the exhaust gas blower 10 and run-out characteristic of the volume flow of the gas turbine 6.

With good regulation of the exhaust gas blower 10, the pressure difference across the flap 17 is virtually zero, so that, in normal operation, neither carbon dioxide-containing exhaust gases escape via the bypass chimney nor ambient air is sucked in via the bypass chimney. An outflow of exhaust gas via the bypass chimney 12 would reduce the effectiveness of carbon dioxide separation. An intake of ambient air by suction via the bypass chimney 12 would result in dilution of the carbon dioxide-containing exhaust gases, with the result that the outlay in terms of carbon dioxide separation could rise and the efficiency of the plant would fall. Secondary streams and thermals in the bypass chimney can be virtually prevented by the largely closed flap 17.

A second exemplary embodiment of a fail-safe open connection is shown in FIG. 4. A main flap 20 and a secondary flap 22 are arranged in the connection region of the bypass chimney 12. Both flaps open beyond a defined pressure threshold, that is to say a defined opening pressure difference. The main flap 20 opens in the flow direction to the bypass chimney and opens the secondary flap 22. The main flap 20 is indicated by dashes as an open main flap 21 and the secondary flap 22 is indicated by dashes as an open secondary flap 23. The gas-tight closed position is illustrated in FIG. 4a by the section A-A.

The opening pressure differences can be defined freely for both throughflow directions and a reliable value is thus defined as a function of the design of the exhaust gas tract.

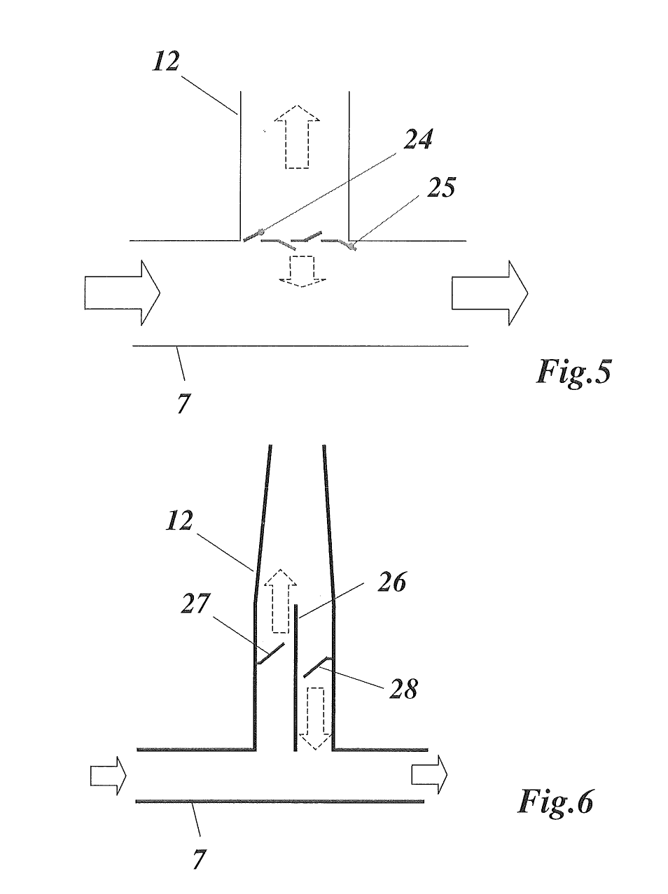

A further exemplary embodiment is shown in FIG. 5. FIG. 5 shows a diagrammatical illustration of a bypass chimney 12, in whose connection to the exhaust gas duct 7 a multiplicity of alternately arranged outward-opening sub flaps 24 and inward-opening sub flaps 25 are arranged. The outward-opening sub flaps 24 allow bypass operation. The inward-opening sub flaps 25 enable outside air to flow into the exhaust gas line 7 and prevent too high an underpressure in the exhaust gas tract in the event of rapid transients.

FIG. 6 shows diagrammatically a further exemplary embodiment. In this example, the bypass chimney 12 is divided into two ducts in the inlet region by a partition 26, in each case an outlet flap 27 or an inlet flap 28 being arranged in a duct. The outlet flap 27 allows bypass operation. The inward flap enables outside air to flow into the exhaust gas line 7 and consequently prevents too high an underpressure in the exhaust gas tract in the event of rapid transients.

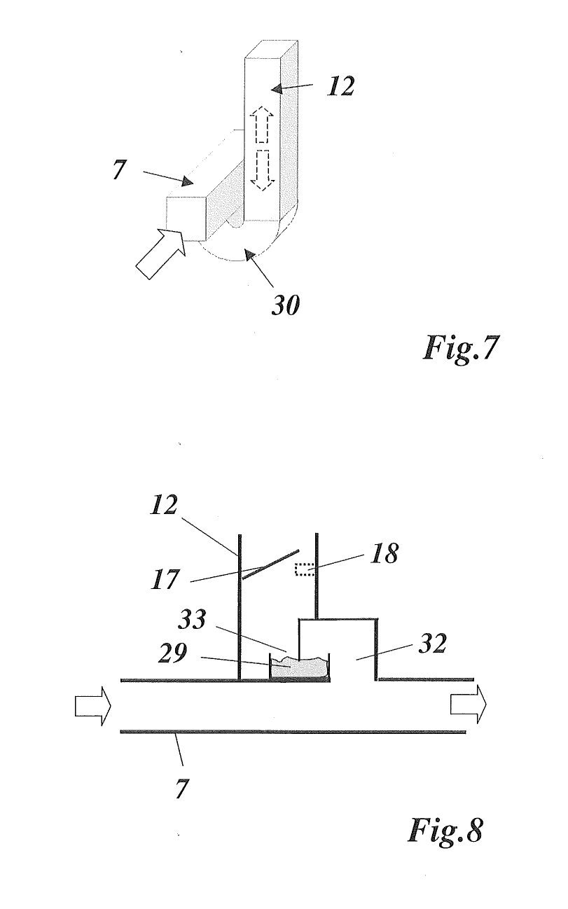

FIG. 7 shows an exemplary embodiment without mechanical flaps. It shows a diagrammatic illustration of a bypass chimney 12 with a chimney elbow 30 which is connected to the exhaust gas line 7 from below and which issues into the bypass chimney 12 after a U-shaped deflection.
In normal operation, the chimney elbow 30 is filled with relatively cool gas and because of the density difference prevents hot exhaust gases from flowing in from the exhaust gas line 7. In normal operation with carbon dioxide separation, the exhaust gas is hotter than the gases in the chimney elbow. The gases in the chimney elbow are therefore heavier and counteract the inflow of exhaust gases into the elbow. Even when exhaust gas flows into the connection region of the chimney elbow as a result of turbulence, it is held in the connection region of the chimney elbow 30 by the thermal which arises. The pressure resistance can be set by means of the height of the U-pipe. Moreover, the U-shaped deflection leads to an additional pressure loss, so that, with the pressure conditions equalized, virtually no gas flows through the bypass chimney during the normal operation of the plant. The straight part of the U-pipe upstream of the deflection may be, for example, 1 m to 3 m high. In a further example for a higher differential pressure, the selected straight part of the U-pipe is, for example, 3 to 7 m. The bypass operation, for example, the exhaust gas line 7 is closed, downstream of the bypass chimney 12, by means of a flap (not illustrated) or the exhaust gas blower 10 is switched off.

FIG. 8 shows a diagrammatic illustration of a further embodiment. In this example, the bypass chimney 12 comprises a water barrier 29.
In the connection of the bypass chimney 12 to the exhaust gas line 7 or in the bypass chimney 12, a basin is arranged which is at least partially filled with water and into which a blow-out duct 32 which branches off from the exhaust gas line 7 extends into the basin from above. Further, a blow-in duct 33 extends from the bypass chimney into the basin from above. The walls of the blow-in duct 33 or of the blow-out duct 32 reach under the water surface, so that no gas can flow through the water barrier 29. By means of overpressure in the respective blow-in duct 33 or blow-out duct 32, the water can be displaced at least partially out of the basin, so that the water barrier 29 opens. The depth of penetration of the duct walls or the height of the water column at which gas throughflow becomes possible determines the pressure threshold for both throughflow directions. This can be determined differently in the two directions by the depth of penetration of the walls of the blow-in duct 33 or of the blow-out duct 32.

1. A gas turbine power plant, comprising a gas turbine, a waste heat steam generator following the gas turbine, an exhaust gas blower, a carbon dioxide separation plant which separates the carbon dioxide contained in the exhaust gases from these and discharges it to a carbon dioxide outlet, and a chimney, wherein the gas turbine, waste heat recovery boiler, exhaust gas blower, carbon dioxide separation plant and chimney being connected by means of exhaust gas lines, and a bypass chimney is arranged between the outlet of the waste heat steam generator and the exhaust gas blower and is connected to a fail-safe open connection both in the throughflow direction from the exhaust gas line to the bypass chimney and in the throughflow direction from the bypass chimney to the exhaust gas line.

2. The gas turbine power plant as claimed in claim 1, wherein the connection of the bypass chimney to the exhaust gas line has a defined pressure threshold beyond which the gas throughflow from the exhaust gas line into the bypass chimney is unobstructed.

3. The gas turbine power plant as claimed in claim 1, wherein the connection of the bypass chimney of the exhaust gas line comprises a flap and a stop, the stop being arranged in such a way that the flap does not close completely and has a minimum opening even in a closed position.

4. The gas turbine power plant as claimed in claim 1, wherein the connection of the bypass chimney to the exhaust gas line comprises a main flap and a secondary flap, the main flap being open, fail-safe, in the throughflow direction from the exhaust gas line to the bypass chimney, and the secondary flap being open, fail-safe, in the throughflow direction from the bypass chimney to the exhaust gas line.

5. The gas turbine power plant as claimed in claim 1, wherein the connection of the bypass chimney to the exhaust gas line comprises a multiplicity of alternately arranged outward-opening sub flaps and inward-opening sub flaps, the outward-opening sub flaps being open, fail-safe, in the throughflow direction from the exhaust gas line to the bypass chimney, and the inward-opening sub flaps being open, fail-safe, in the throughflow direction from the bypass chimney to the exhaust gas line.

6. The gas turbine power plant as claimed in claim 1, wherein the bypass chimney is divided into two ducts at the connection to the exhaust gas line by means of a partition, there being arranged in one duct an outlet flap which is open, fail-safe, in the throughflow direction from the exhaust gas line to the bypass chimney, and there being arranged in the second duct an inlet flap which is open, fail-safe, in the throughflow direction from the bypass chimney to the exhaust gas line.

7. The gas turbine power plant as claimed in claim 1, wherein the bypass chimney is connected to the exhaust gas line via a chimney elbow, the chimney elbow being connected to the exhaust gas line from below and having a U-shaped deflection, and the U-shaped deflection issuing into the bypass chimney.

8. The gas turbine power plant as claimed in claim 1, further comprising a water barrier is arranged at the connection of the bypass chimney to the exhaust gas line or in the bypass chimney and comprises a basin which is filled at least partially with water and into which a blow-out duct extends from the exhaust gas line into the basin from above and a blow-in duct extends from the bypass chimney from above, in the closed state of the water barrier the blow-out duct and the blow-in duct reaching under the water surface, so that no gas flows through the water barrier, and the water being at least partially displaceable out of the basin as a result of overpressure in the respective duct, and so that the water barrier can consequently be transferred into an open state in which gas can flow through the water barrier.

9. A method for operating a gas turbine power plant, having a gas turbine, a waste heat steam generator following the gas turbine, an exhaust gas blower, a carbon dioxide separation plant which separates the carbon dioxide contained in the exhaust gases from these and discharges it to a carbon dioxide outlet, and a chimney, wherein the gas turbine, waste heat recovery boiler, exhaust gas blower, carbon dioxide separation plant and chimney being connected by means of exhaust gas lines, and in which a bypass chimney is arranged between the outlet of the waste heat steam generator and the exhaust gas blower and is connected to a fail-safe open connection both in the throughflow direction from the exhaust gas line to the bypass chimney and in the throughflow direction from the bypass chimney to the exhaust gas line; the method comprising regulating the exhaust gas blower such that the differential pressure between the inside of the exhaust gas line and the surroundings at the connection of the bypass chimney of the exhaust gas line remains lower than a pressure threshold, wherein the pressure threshold being lower than a design pressure difference of the waste heat steam generator.

10. The method for operating a gas turbine power plant as claimed in claim 9, wherein the pressure threshold is lower than one third of the pressure losses of the waste heat recovery boiler under design conditions.

11. The method for operating a gas turbine power plant as claimed in claim 9, wherein the pressure threshold is 3 to 10 mbar.
